(19) United States
(12) Patent Application Publication
(10) Pub. No.: US 2006/0032348 A1
(43) Pub. Date: Feb. 16, 2006

(54) Method of cutting a sheet and reducing the remnant material

(76) Inventors: Mikko Veikkolainen, Espoo (FI); Jukka Gustafsson, Mynamaki (FI); Juhani Saikko, Helsinki (FI)

Correspondence Address: SMITH-HILL AND BEDELL, P.C., 16100 NW CORNELL ROAD, SUITE 220, BEAVERTON, OR, 97006, US

(21) Appl. No.: 10/516,844

(22) PCT Filed: Jun. 10, 2003
(86) PCT No.: PCT/FI03/00460

§ 371 Date: Dec. 3, 2004

(30) Foreign Application Priority Data
Jun. 12, 2002 (FI) 20021138

(51) Int. Cl. B26D 1/00

(52) U.S. Cl. 83/13

(57) ABSTRACT

The invention relates to a method of cutting a sheet-like piece into one or several smaller pieces by using camera means and a controllable cutting apparatus, the directions and values of the coordinate systems of which are calibrated to correspond to each other. In the method the following measures are taken: the piece to be cut is placed on a cutting surface located within the recording area of the camera means, the piece is photographed by the camera means and on the basis thereof the outlines of the piece are determined and the information on the outlines of the piece is input into the positioning system, where the cutting paths are established and input into the control system of the cutting device, which determines necessary parameters for the cutting and on the basis of these, controls the cutting of the piece into parts according to given instructions.

The invention relates to a method of cutting a sheet-like piece by utilizing camera means and a controllable cutting apparatus in accordance with the preamble of claim 1.

A lot of so-called remnant sheet is produced by the shipbuilding work, when larger sheet objects are manufactured by thermal cutting. On the other hand a ship comprises a great number of small standard components, the annual need of which is several thousands of pieces, and the aim is to use remnant sheet as a material for these components, where possible. While manufacturing standard components, the machine operator has to use excessively much time for utilizing the remnant pieces. Today, the utilization of remnant sheet is not cost-effective from the technical and economical point of view and the problem when using remnant material has been the difficulty in positioning standard components on a remnant sheet having an irregular shape, and thus the scrub percentage has been fairly high. Conventionally, the utilization of remnant material has stayed on a level, where the machine operator measures by hand a rectangular area on the remnant sheets, inputs the data into the machine control and starts positioning components on the defined area. Being a task of the machine operator the positioning is in its present form far too time-consuming, and the outcome is not economical in terms of working hours and consumption of material. In practice, the machine operator has to make also a physical effort when taking the cutting machine to the starting point of the cutting program.

An aim of the present invention is to overcome the disadvantages related to prior art and provide a novel solution, where said disadvantages can be eliminated as efficiently as possible.

The aim of the invention can be achieved as is described in claim 1 and in the other claims.

According to the invention following measures are taken: the piece to be cut is placed on a cutting surface located within the recording area of camera means, the piece is photographed by the camera means and on the basis thereof the outlines of the piece are determined and the information on the outlines of the piece is input into the positioning system, where the cutting paths are established and input into the control system of the cutting machine, which determines necessary parameters for the cutting and on the basis of these, controls the cutting of the piece into parts according to given instructions. Thus, the invention enables the use of machine vision for defining the sheet blank so as to provide and implement a cutting program. Preferably, also automation may be applied to the positioning of the pieces to be cut on the remnant sheet. Thus the invention enables an economical utilization of remnant sheet material in the positioning the pieces to be cut, and minimises manual work and the scrub percentage of the remnant sheet material. Here, the outlines of the piece also refer to the shape of such parts of the pieces, e.g. openings, which remain inside the piece. Also, the invention is preferably applicable to the utilization of remnant sheet objects, which are irregular in shape, in a most optimal way.

Once the outlines and dimensions of the piece have been determined, positioning data is created by selecting at least one type of a small part and adding a desired number of said at least one type of small parts to the outline image inside the outlines. For the positioning a suitable program may be used for instance by selecting a certain type of a small part from the macro-library, whereby the program fills the sheet-like piece with said parts. The positioning may also be based on selecting several different kinds of small parts. Alternatively, also the operator himself may draw by the program a desired kind of a small part and place a certain number of these on the sheet-like piece.

In the automatic positioning on a remnant sheet the cutting paths, starting points and volumes as well as the use of material are optimised. Also the starting point of the cutting and the cutting path may be determined either by the operator or automatically. After the determination, the positioning data is input into the control system of the cutting apparatus, whereby the operation of the cutting machine changes from an incremental, i.e. from a sheet blank specific, coordinate system proportioned to the zero point over to an absolute coordinate system, i.e. to a coordinate system covering the whole work station. A numerically controlled flame cutting machine, a manipulator or a robot is preferably used as a cutting apparatus.

As ancillary equipment while photographing the object, a light source to be reflected, most preferably a laser bar, may be used to facilitate the detectability and/or to provide additional information. In the method according to the invention the working area is illuminated for photographing to such an extent that the illumination conditions are as constant as possible so as to make the outlines and position of the piece visible with sufficient accuracy. The illumination and the bars or matrices to be reflected facilitating the detectability are complementary to each other. The photographing according to the method may be performed by one or several cameras, preferably CCD-cameras, which may be located in the cutting apparatus, in a separate portal moving on the same guide rails as the cutting apparatus or in external structures, e.g. at the ceiling of the working area, or by means of a separate guide rail in outside structures.

The pieces to be cut compose parts of a metal structure, which most preferably may be intended for a watercraft, ship or another marine equipment, but the invention may as well be applied to other kinds of objects, where sheet metal pieces are utilized.

In the following the invention is described by way of example with reference to the attached drawings, in which

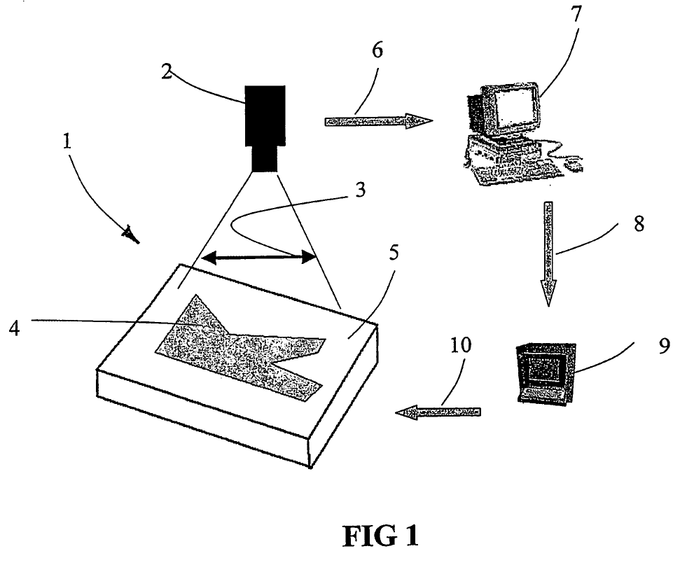

FIG. 1 shows a functional diagram for utilizing remnant material in the manufacture of sheet objects; and

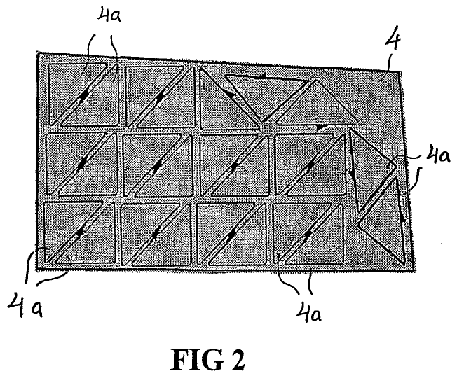

FIG. 2 shows a positioning layout.

In a machining arrangement 1 according to FIG. 1, i.e. in this case thermal cutting, an image of the cutting area 3 of a cutting apparatus is provided by camera means 2 to be attached to a cutting machine, to a separate guide rail or to structures surrounding the machine. The shape and dimensions of the outlines of a sheet blank 4 comprising a remnant sheet and located within the cutting area 3 are determined by means of the image provided by the camera. The sheet blank 4 is placed on a cutting surface 5, which may comprise for instance a floor or a machining table. The determination of the dimensions may be performed by software according to software algorithms or manually by the operator by pointing at the display. As ancillary equipment for the determination an illumination and a light source to be reflected, preferably a helium-neon laser bar, may be used for facilitating the detectability. The result of the determination is data, i.e. so-called image data 6, including the dimensions of the outlines of the sheet blank 4 and its location in the working area 3, which data is transferred over to a positioning system 7, where a desired number of certain type of small parts is placed on the area. For instance a certain type of a small part may be selected from the macro-library and the positioning program may be arranged so as to fill the sheet blank with said parts. Alternatively, also the operator himself may draw by the program a small part having a desired shape and place a certain number of these parts on the sheet blank, and if desired, a certain number of some other kinds of small parts, if there is still open space on the sheet blank. The positioning data is then input into the control system of the cutting apparatus, which actuates a cutting program 8.

The positioning system 7 may be located either on a separate computer 7 or in conjunction with a machine control 9. Information on a sheet blank 4 having any kind of a shape is received easily and fast with the assistance of the system and it is possible to optimise the use of the blank and minimize the scrub percentage by means of computer-based automatic positioning. In addition to the dimensions of the sheet blank 4, the machine vision system is capable of indicating also the position of a reference angle or starting angle in the working area 3 of the cutting apparatus (not shown in detail), whereby a separate relocation of the cutting apparatus, which used to be carried out manually, is unnecessary, and the cutting 10 of the sheet blank 4 may be started. Thus both time and material can be saved by the invention, meanwhile the operation efficiency improves and the costs decrease.

The cutting may be performed by methods known per se, e.g. by gas cutting or plasma cutting. One advantageous method is numerically controlled thermal cutting, where the parameters for cutting, e.g. the cutting speed, the size of the cutting grooves etc., may be determined by numerical control. The cutting apparatus may run itself to the starting point and start the cutting.

FIG. 2 shows an example of a positioning and cutting layout, which may be realized by inputting the layout into a numerically controlled cutting machine. Here, a number of sheet-like small parts 4a, which are all alike, are placed on a sheet blank 4. Some of these could, of course, be replaced by other kinds of parts. The cutting directions are indicated by arrows.

It is evident for a person skilled in the art that the invention is not limited to the above-described application, but various modifications of the invention are conceivable in the scope of the inventive conception defined by the appended claims.

1-7. (canceled)

8. A method of cutting a sheet-like piece of metal into one or several smaller pieces by using camera means and a controllable cutting apparatus, the directions and values of the coordinate systems of which are calibrated to correspond to each other, characterized in that following measures are taken:
the piece to be cut is placed on a cutting surface located within the recording area of the camera means,
the piece is photographed by the camera means and on the basis thereof the outlines of the piece are determined,
the information on the outlines of the piece is input into the positioning system, where positioning data is created by selecting at least one type of a small part and, when applicable, adding a desired number of said at least one type of small parts into the outline image inside the outlines and the cutting paths are established and input into the control system of the cutting machine which determines necessary parameters for the cutting and on the basis of these the cutting of the piece into parts is carried out on said cutting surface under the control of the said control system according to given instructions.

9. A method according to claim 8, characterized in that also the starting point of the cutting and the cutting path are determined automatically or by operator-aided means, and the positioning data is input into the control system of the cutting apparatus.

10. A method according to claim 8, characterized in that in the automatic positioning on the sheet the cutting paths, starting points and volumes as well as the use of material are optimized.

11. A method according to claim 8, characterized in that the operation of the cutting apparatus changes from an incremental, i.e. a sheet blank specific, coordinate system proportioned to the zero point over to an absolute coordinate system, i.e. to a coordinate system covering the whole work station.

12. A method according to claim 8, characterized in that a numerically controlled thermal cutting machine, a manipulator or a robot is used as a cutting apparatus.

13. A method according to claim 8, characterized in that as ancillary equipment while photographing the object, a light source to be reflected, most preferably a laser bar, may be used to facilitate the detectability and/or to provide additional information.

14. A method according to claim 8, characterized in that the pieces to be cut compose parts of a metal structure, for instance a watercraft, ship or another marine equipment, a bridge, paper machine, building, vehicle such as a train, lorry, mining vehicle or a tank or a platform structure.
